(19) United States
(12) Patent Application Publication
(10) Pub. No.: US 2020/0223086 A1
(43) Pub. Date: Jul. 16, 2020

(54) TOOL FOR CUTTING CYLINDRICAL CONDUITS

(71) Applicant: Scott Cutters UK Limited, Beaconsfield Buckinghamshire (GB)

(72) Inventor: Scott Rampling, Beaconsfield Buckinghamshire (GB)

(73) Assignee: Scott Cutters UK Limited, Beaconsfield Buckinghamshire (GB)

(21) Appl. No.: 16/614,738

(22) PCT Filed: May 16, 2018
(86) PCT No.: PCT/GB2018/051322

§ 371 Date: Nov. 18, 2019

(30) Foreign Application Priority Data
May 17, 2017 (GB) 1707933.6
Nov. 8, 2017 (GB) 1718459.9

(51) Int. Cl. B26D 3/16; B23D 21/08; B23D 21/10; B26D 7/02

(52) U.S. Cl. CPC B26D 3/169; B26D 7/02; B23D 21/10; B23D 21/08

(57) ABSTRACT

A tool (1) for cutting cylindrical conduits. The tool comprises a body (2) having an opening (3) extending along a predetermined axis through the body. A slot (4) extends from an external surface (5) of the body to a mouth (6) of the opening (3). A cutting blade (14) extends into the opening along a plane extending at right angles to said predetermined axis. The body has a first portion (7) on one side of the slot (4) and a second portion (8) on the other side of the slot.

The present disclosure relates to a tool, in particular to a tool suitable for cutting cylindrical conduits. The tool may be arranged such that cylindrical conduits of varying diameters may be cut.

Plastic piping is increasingly used in plumbing systems to feed water, replacing conventionally used copper piping due to its comparatively low cost. It is further used, for example, in the electrical field for the passage of electrical cables, or otherwise.

Conventional cutting tools typically involve engaging the pipe between a pair of spaced rollers and a cutting disc, and rotating the tool about the pipe whilst the tool is progressively tightened by means of a screw mechanism. The process of incrementally tightening and rotating the tool eventually results in the total severance of the pipe into two lengths. However, such tools are relatively expensive and their operation is somewhat tedious. Also, when used with plastic pipes, the pressure exerted by the tool can cause deformation of the pipe.

UK Patent No GB 2457346 discloses a cutting tool suitable for cutting a cylindrical plastic conduit having a predetermined external diameter. However, the tool is not suitable for cutting cylindrical plastic conduits of varying diameters and thus a range of differently sized cutting tools are needed to cut differently sized conduits. The cutting tool suffers from several further drawbacks.

It is the object of the present invention to provide an improved cutting tool.

According to the present invention in a first aspect, there is provided a tool for cutting cylindrical conduits of varied diameters, said tool comprising: a body having an opening extending along a predetermined axis through the body, a slot extending from an external surface of the body to a mouth of the opening, a first portion of the body being provided on one side of the slot and a second portion of the body being provided on the other side of the slot, a cutting blade extending into said opening along a plane extending at right angles to said predetermined axis, and a flexible conduit holder that is connected to the body and provided within the opening.

The first portion may be generally rigid and inflexible whilst the second portion is resilient and flexible; or both the first and second portions may be resilient and flexible.

The arrangement is such that the progressive insertion of a conduit into the opening along the slot will cause the first and second portions initially to flex away from one another until the conduit enters the opening and is received by the flexible conduit holder, whereafter the first and/or second portions will resile, causing the flexible conduit holder to conform to the conduit and urging the conduit against the blade, so that relative rotation between the tool and conduit about the predetermined axis will result in the severing of the conduit. The slot may taper so that its width progressively diminishes with distance from the external surface of the body to the mouth of the opening.

A major advantage of the present invention is that the tool may receive conduits of varying external diameters into the opening, without deforming the conduits. When a conduit is inserted, the flexible conduit holder substantially conforms to the outer circumference of the conduit, thus supporting the conduit within the opening during the cutting operation and providing a clean cut, without deforming the conduit. To this end the flexible conduit holder preferably has greater flexibility than the second portion of the body.

Preferably, the flexible conduit holder is separately formed to the body and is attached thereto. The flexible conduit holder may advantageously be formed of a material that allows it to retain its original shape when in a relaxed state even after multiple deformations. It may be formed from plastic, spring steel or any other suitable flexible/resilient material.

To enhance the “memory” of the tool, and aid the body of the tool retain its original shape when in a relaxed/rest state even after multiple deformations, there may be provided a biasing means for biasing the first and second portions of the body apart from one another. The biasing means may be arranged to maintain the tool in a predetermined rest position with the mouth of the opening open. The biasing means will preferably be formed separately to the body of the tool. It may be formed from a different material to the body. If the body is substantially formed from plastic the biasing means may be metal. It may comprise spring steel. It will preferably comprise a suitably formed spring, which may extend between the first and second body portions.

The flexible conduit holder is preferably unitarily formed.

In preferred embodiments of the present invention, the flexible conduit holder may comprise a hinge, which hinge may be a living hinge. The living hinge may have a curved profile.

Preferably, the flexible conduit holder comprises first and second conduit support portions that are joined to one another by an intermediate portion that permits relative movement between the first and second conduit support portions. The first and second conduit support portions preferably comprise faces. At least one of the conduit support portions/faces may be curved. It is preferable that both conduit support portions/faces are curved. One or both of the conduit support portions/faces may be provided with a plurality of projections or indentations. The projections or indentations may define ribs that extend parallel to the predetermined axis. The intermediate portion preferably permits both pivotal and radial movement between the conduit support portions/faces. The conduit support portions/faces are, moreover, preferably flexible themselves. The arrangement is such that one or both of the conduit support portions/faces is/are able to conform to the outer circumference of a variety of conduits having a range of external diameters. The intermediate portion may comprise said hinge.

The flexible conduit holder may be attached on a first side thereof to the first portion of the body and further on a second side thereof to the second portion of the body. In such an arrangement, each of the conduit support portions is associated with a respective one of the first and second portions. Thereby, as the second portion of the body is caused to flex away from the first portion of the body upon insertion of a conduit into the slot, the second side of the flexible conduit holder (and its associated conduit support portion) is concurrently caused to flex away from the first side of the flexible conduit holder (and its associated conduit support portion).

The arrangement may be such that the flexible conduit holder is fixed to the first conduit support portion at/adjacent a front edge of the first conduit support portion/face and is fixed to the second conduit support portion at/adjacent a front edge of the second conduit support portion/face. (The front edges of the conduit support portions/faces being the edges thereof that are distal the intermediate portion). The flexible conduit holder may be fixed to the body at these points only with its movement relative to the body otherwise substantially unconstrained. The flexible conduit holder may comprises a (substantially radially) outwardly extending leg for contacting the body or for attachment to the body. The body may comprise an opening for receiving the leg.

The flexible conduit holder may be fixed to the first portion by the leg. The leg may be flexible. The leg may be hingedly received by the opening. For this purpose, an edge portion of the leg that is received by the opening may have an enlarged section which is held in a complimentary enlarged section of the opening. The enlarged sections may be in the form of a ball and socket when viewed in cross-section. The shapes and dimensions of the leg and opening may permit rotation of the leg within the opening but prevent movement of the leg out of the opening. The opening may comprise a channel for receiving the leg. The leg may extend along substantially the entire length of the flexible conduit holder in the axial direction. The leg may be free to move within the channel to prevent any hindrance of the movement of the flexible conduit holder. The leg may act like a gasket to prevent the ingress of dirt or other material beneath the flexible conduit holder.

Preferably, the flexible conduit holder spans the mouth of the opening, such that a conduit inserted into the opening is accommodated within the flexible conduit holder and thereby supported within the opening by the flexible conduit holder.

The cutting blade may be attached to the body and protrude through the flexible conduit holder into the opening. The blade preferably penetrates the respective portion/face of the flexible conduit holder associated with the portion of the body provided with the cutting blade. The flexible conduit holder may comprise an aperture, through which the cutting blade extends into the opening. The aperture may comprise a slit. By such arrangement, the flexible conduit holder will move independently of/relative to the blade and the depth of exposure of the blade will be varied in dependence on the diameter of the conduit received by the flexible conduit holder.

The cutting blade may be square or rectangular in shape. The cutting blade may alternatively be arcuate or circular. In embodiments comprising a circular blade, the circular blade may be rotatably attached within the body. The use of a rotatably mounted circular blade, ie.e. a cutting wheel, is of particular benefit for cutting plastic conduits that comprise metal layers, such as “barrier pipes” used in underfloor heating systems.

A portion of the flexible conduit holder that is located beyond a portion of a cutting edge of the blade, when viewed through the slot, is preferably flexibly mounted. That is, the flexing of the flexible conduit holder is substantially unhindered in this portion. This portion preferably lies in free space in the opening.

The flexible conduit holder preferably extends along substantially the entire axial length of the opening.

The body of the tool may comprise two axially spaced halves which are joined together. The blade may be sandwiched between the two axially spaced halves.

The first portion may comprise a first part, which is attached to the second portion, and a second part, which is hinged to rotate relative to the first part about an axis. The axis of rotation of the second part may be parallel to the predetermined axis. The first part may be unitarily formed with the second portion. Abutting faces of the first and second parts may be provided with interlocking members. The interlocking members may comprise a rib and a groove, which may be arced. A plurality of ribs and grooves is preferably provided, which ribs and grooves are concentric about the axis of rotation of the second part. The blade may be sandwiched between the first and second parts. The second part may be rotatable between a first position in which the blade is obstructed to prevent its removal and a second position in which the blade can be removed. A locking means may be provided for locking the second part against rotation, which may comprise a single screw.

The tool may further comprise a blade guard, which blade guard extends into the opening to wholly or partially cover the cutting blade, thus providing the user with protection from accidental injury from an exposed blade. The blade guard is preferably slidably or pivotably attached to the body, such that insertion of a conduit into the opening will cause the guard to retract and thus allow the conduit to come into contact with the blade. The blade guard may be spring loaded.

The tool may additionally comprise a compartment for storing blades.

Preferably, at least a portion of a cutting edge of the blade is recessed from the mouth of the opening in a direction of a straight line extending between innermost edges of the slot. A conduit which is inserted into the opening through the mouth will thereby only make contact with the blade once the conduit has been wholly inserted into the opening.

The slot may comprise a pair of opposed sidewalls, wherein one or both of the sidewalls is provided with an inwardly projecting protrusion that lies in the plane of the blade, the flexible conduit holder being free from any such protrusion. Advantageously, the protrusion provides a guide for the insertion of corrugated conduits into the flexible conduit holder.

A leading end of a cutting edge of the cutting blade may be provided proximal the mouth of the opening, a ramp may be provided that tapers away from the leading end of the cutting edge in a direction towards the mouth of the opening. In a particularly preferred arrangement, the ramp may be defined by a non-cutting edge of the cutting blade, which tapers away from the leading end of the cutting edge in a direction towards the mouth of the opening. In alternative arrangements it may be formed by a rib or fin that is attached to or integrally formed with the body and which may be formed from plastic. The ramp and the cutting edge preferably meet at an apex.

The cutting blade may extend into the opening by the greatest depth at the leading end of a cutting edge of the cutting blade. The depth of extension of the cutting edge of the blade into the opening preferably diminishes with distance away from the mouth of the opening. The cutting edge may be straight. The ramp/non-cutting edge may be straight. The cutting edge and the ramp/non-cutting edge are preferably arranged at an oblique angle to one another. The cutting edge and the ramp/non-cutting edge may be arranged at an angle of between 30 and 60 degrees to one another.

Preferably, one of the first and second portions is provided with the blade, and a sidewall of the slot, which is associated with the respective one of the first and second portions that is provided with the blade, comprises a guide surface, and the ramp/non-cutting edge of the blade is aligned with the guide surface. The guide surface may be straight. Preferably, the guide surface and ramp/non-cutting edge together define a ramp along which a cylindrical conduit may travel before engaging the cutting edge of the cutting blade.

According to a second aspect of the present invention, there is provided a tool for cutting cylindrical conduits, said tool comprising: a body having an opening extending along a predetermined axis through the body, a slot extending from an external surface of the body to a mouth of the opening, the body has a first portion on one side of the slot and a second portion on the other side of the slot, and a cutting blade extending into said opening along a plane extending at right angles to said predetermined axis, wherein at least a portion of a cutting edge of the blade is recessed from the mouth of the opening in a direction of a straight line extending between innermost edges of the slot.

The arrangement of the second aspect of the present invention is again such that the progressive insertion of a conduit into the opening along the slot will cause the first and second portions initially to flex away from one another until the conduit enters the opening, whereafter the first and/or second portion will resile, urging the conduit against the blade, so that relative rotation between the tool and conduit about the predetermined axis will result in the severing of the conduit. The slot may taper so that its width progressively diminishes with distance from the external surface of the body to the mouth of the opening.

By the recessing of the blade, the conduit will only contact the cutting blade once the conduit is wholly inserted through the mouth into the opening. This prevents the conduit catching on the blade of the tool prior to the full insertion of the conduit into the opening, whereby its axis could be other than parallel to the predetermined axis, causing uneven severance of the conduit. By the arrangement of the second aspect, a conduit which is only partially inserted through the mouth will remain spaced from the cutting blade, due to the cutting blade being recessed from the mouth of the opening.

Preferably, the entire cutting edge of the blade is recessed from the mouth of the opening.

Preferably, one of the first and second portions is provided with the blade, and a sidewall of the slot, which is associated with the respective one of the first and second portions that is provided with the blade, comprises a guide surface, and the cutting edge of the blade is recessed from an edge of the guide surface in the direction of the straight line extending between innermost edges of the slot, which edge is located at the mouth of the opening.

The guide surface may comprise a ramp. The sidewall of the slot may define the guide surface, in which case the guide surface will extend for the entire length of the mouth in the axial direction. The guide surface may, alternatively, be formed by a projection on the sidewall of the slot. There may be two or more spaced projections. The guide surface may be straight or curved.

The blade may be any of square, rectangular or arcuate in shape. The blade may be circular and rotatably mounted to the body.

The cutting edge may be straight or curved and increasingly recessed from the mouth of the opening as it extends away from the mouth of the opening.

Any of the features of the second aspect of the invention may be provided in combination with any of the aforementioned features of the first aspect of the invention.

According to a third aspect of the present invention, there is provided a tool for cutting cylindrical conduits, said tool comprising a body having an opening extending along a predetermined axis through the body, a slot extending from an external surface of the body to the opening, a cutting blade extending into said opening along a plane extending at right angles to said predetermined axis, wherein the body has a first portion on one side of the slot and a second portion on the other side of the slot, and wherein the slot comprises a pair of opposed sidewalls and one or both of the sidewalls is provided with an inwardly projecting protrusion that lies on the plane of the blade, the opening being free from any such protrusion.

The arrangement of the third aspect of the present invention is again such that the progressive insertion of a conduit into the opening along the slot will cause the second portion initially to flex away from the first portion until the conduit enters the opening, whereafter the first and/or second portion will resile, urging the conduit against the blade, so that relative rotation between the tool and conduit about the predetermined axis will result in the severing of the conduit. The slot may taper so that its width progressively diminishes with distance from the external surface of the body to the mouth of the opening.

The arrangement of the third aspect of the present invention allows the tool to be used for cutting corrugated conduits, which conduits comprise a series of axially spaced peaks and troughs. The protrusion(s) may be used to align a trough of the corrugated conduit with the cutting blade, such that insertion of a conduit into the opening will locate the cutting blade within a trough, allowing the conduit to be severed in a trough at right angles to the central axis of the cutting blade. Clearly, the protrusion will further aid in alignment of the axis of the conduit with the axis of the opening. The width of the protrusion is preferably configured to be less than or equal to that of a typical trough of such a corrugated conduit.

The protrusion may comprise a rib projecting inwardly generally at right angles to the predetermined axis. The rib may extend across all or part of the length of the sidewall of the slot in a direction from the external surface of the body to the mouth of the opening.

In further embodiments of the present invention according to the third aspect, the tool may further comprise a flexible conduit holder that is connected to the body and provided within the opening. Preferably, the flexible conduit holder is again free from any protrusion lying in the plane of the blade.

The protrusion may be retractable or removable. Accordingly, the tool can be configured for cutting either corrugated or smooth conduits according to the needs of a user. The protrusion may be formed by a removable insert.

Preferably, one of the first and second portions is provided with the blade, and the sidewall of the slot, which is associated with the respective one of the first and second portions that is provided with the blade, comprises a guide surface, and the insert is receivable by the body in first and second orientations, wherein the protrusion only projects from the guide surface in the first orientation. In the second orientation, the insert may lie flush with the surface. The insert may be slideably received by the body.

Any of the features of the third aspect of the present invention may be provided in combination with any of the aforementioned features of the first and/or second aspects of the invention.

According to a fourth aspect of the present invention, there is provided a tool for cutting cylindrical conduits, said tool comprising: a body having an opening extending along a predetermined axis through the body, a slot extending from an external surface of the body to a mouth of the opening, a first portion of the body being provided on one side of the slot and a second portion of the body being provided on the other side of the slot, and a cutting blade extending into said opening along a plane extending at right angles to said predetermined axis, wherein the first portion comprises a first part, which is attached to the second portion, and a second part, which is hinged to rotate relative to the first part about an axis.

The arrangement of the fourth aspect of the present invention is again such that the progressive insertion of a conduit into the opening along the slot will cause the first and second portions initially to flex away from one another until the conduit enters the opening, whereafter the first and/or second portion will resile, urging the conduit against the blade, so that relative rotation between the tool and conduit about the predetermined axis will result in the severing of the conduit. The slot may taper so that its width progressively diminishes with distance from the external surface of the body to the mouth of the opening.

The arrangement of the fourth aspect of the present invention allows for straightforward blade replacement, obviating the need to dismantle the entire tool.

The axis of rotation of the second part is preferably parallel to the predetermined axis. The first part may be unitarily formed with the second portion. Abutting faces of the first and second parts may be provided with interlocking members. The interlocking members may comprise a rib and a groove, which may be arced. A plurality of ribs and grooves is preferably provided, which ribs and grooves are concentric about the axis of rotation of the second part. The blade may be sandwiched between the first and second parts. The second part may be rotatable between a first position in which the blade is obstructed to prevent its removal and a second position in which the blade can be removed. A locking means may be provided for locking the second part against rotation, which may comprise a single screw.

Any of the features of the fourth aspect of the present invention may be provided in combination with any of the aforementioned features of the first, second and/or third aspects of the invention.

According to a fifth aspect of the present invention, there is provided a tool for cutting cylindrical conduits, said tool comprising: a body having an opening extending along a predetermined axis through the body, a slot extending from an external surface of the body to a mouth of the opening, a first portion of the body being provided on one side of the slot and a second portion of the body being provided on the other side of the slot, and a cutting blade extending into said opening along a plane extending at right angles to said predetermined axis, wherein a leading end of a cutting edge of the cutting blade is provided proximal the mouth of the opening, and a ramp is provided, which tapers away from the leading end of the cutting edge in a direction towards the mouth of the opening,

In a particularly preferred arrangement, the ramp may be defined by a non-cutting edge of the cutting blade, which tapers away from the leading end of the cutting edge in a direction towards the mouth of the opening. In alternative arrangements it may be formed by a rib or fin that is attached to or integrally formed with the body and which may be formed from plastic.

The arrangement of the fifth aspect of the present invention is again such that the progressive insertion of a conduit into the opening along the slot will cause the first and second portions initially to flex away from one another until the conduit enters the opening, whereafter the first and/or second portion will resile, urging the conduit against the blade, so that relative rotation between the tool and conduit about the predetermined axis will result in the severing of the conduit. The slot may taper so that its width progressively diminishes with distance from the external surface of the body to the mouth of the opening.

The arrangement of the fifth aspect prevents blade damage with the ramp/tapered front portion protecting the cutting edge. The tapered front portion prevents the blade from catching on the blade of the tool prior to the full insertion of the conduit into the opening. It also has the benefit that if the conduit is inserted and an attempt is made to rotate the tool and conduit relative to one another in the wrong direction, the blade will not dig into the conduit but rather the conduit will be ejected from the tool.

The cutting blade may extend into the opening by the greatest depth at the leading end of a cutting edge of the cutting blade. The depth of extension of the cutting edge of the blade into the opening preferably diminishes with distance away from the mouth of the opening. The cutting edge may be straight. The ramp/non-cutting edge may be straight. The cutting edge and the ramp/non-cutting edge are preferably arranged at an oblique angle to one another. The cutting edge and the ramp/non-cutting edge may be arranged at an angle of between 30 and 60 degrees to one another.

Preferably, one of the first and second portions is provided with the blade, and a sidewall of the slot, which is associated with the respective one of the first and second portions that is provided with the blade, comprises a guide surface, and the ramp/non-cutting edge of the blade is aligned with the guide surface. The ramp/guide surface may be straight. Preferably, the guide surface and ramp/non-cutting edge together define a ramp along which a cylindrical conduit may travel before engaging the cutting edge of the cutting blade.

Any of the features of the fifth aspect of the present invention may be provided in combination with any of the aforementioned features of the first, third and/or fourth aspects of the invention.

Any of the first to fourth aspects of the present invention may further comprise a biasing means for biasing the first and second portions of the body apart from one another. The biasing means is preferably arranged to maintain the tool in a predetermined rest position with the mouth of the opening open. The biasing means preferably comprises a spring. The biasing means may be formed separately to the body of the tool. The body may be substantially formed from plastic. The biasing means may be formed from metal, in particular spring steel. The biasing means may comprise a strip of material. Where a flexible conduit holder is provided, the biasing means is provided rearwards of the flexible conduit holder from the slot. The biasing means preferably extends between the first and second body portions.

Non-limiting embodiments will now be described, by way of example only, with reference to the accompanying drawings, in which:

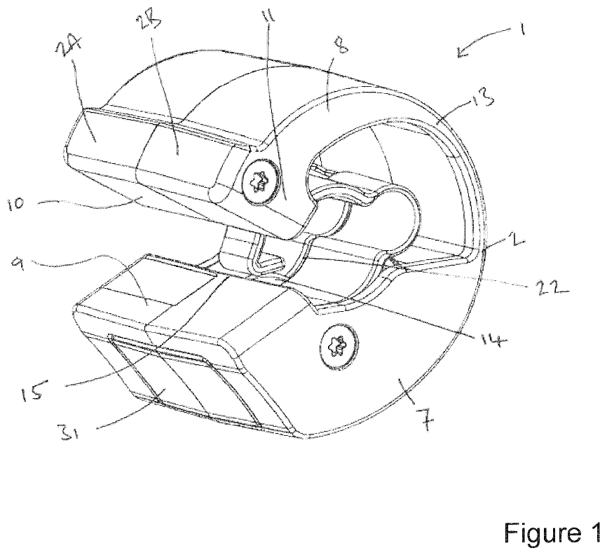

FIG. 1 is a perspective view of a tool according an embodiment of the present invention as viewed from the front;

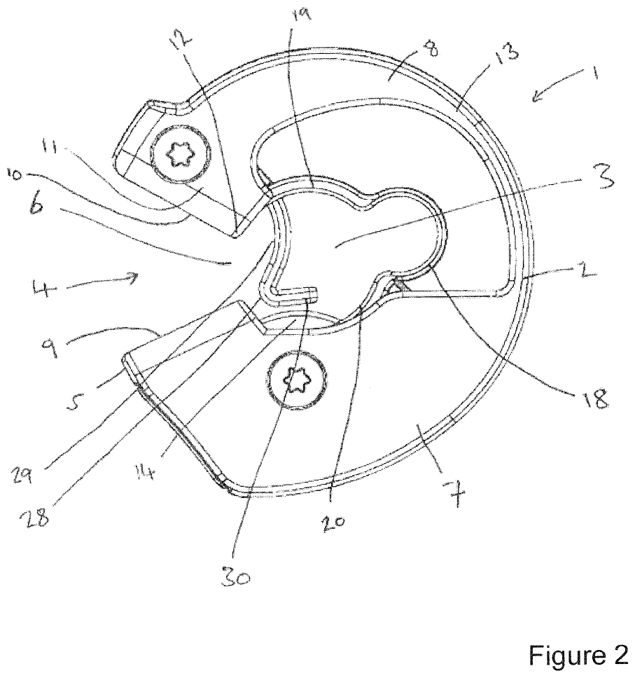

FIG. 2 is a side view of the tool of FIG. 1;

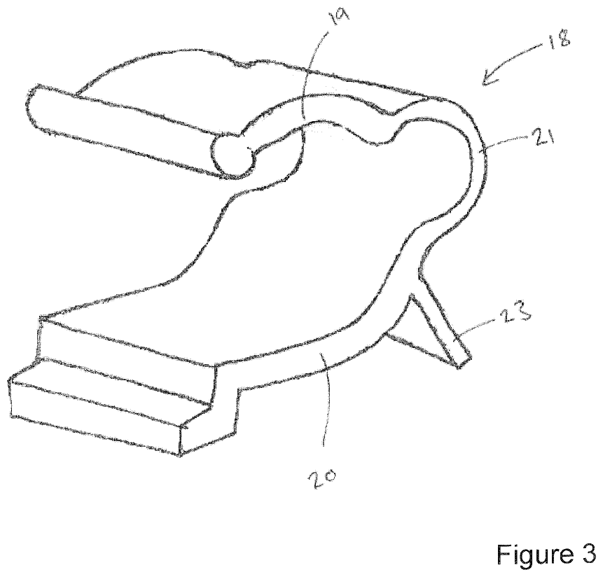

FIG. 3 is a perspective view of the flexible conduit holder in isolation from the body of the tool;

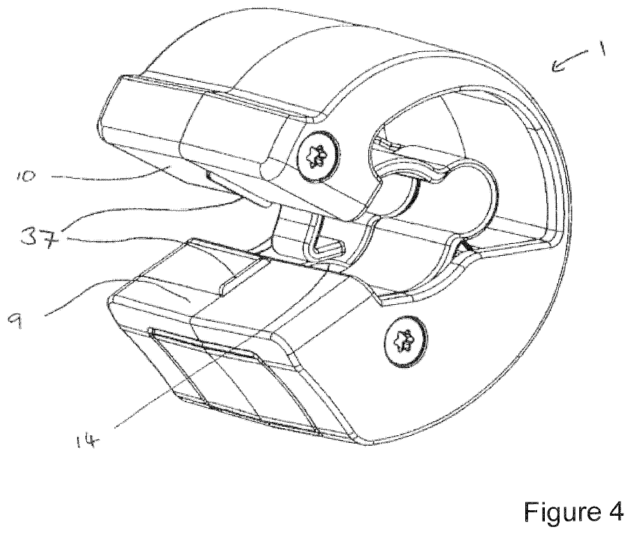

FIG. 4 is perspective view of the tool of FIG. 1 as viewed from the front with the protrusion insert in a first orientation with the protrusion projecting from the guide surface;

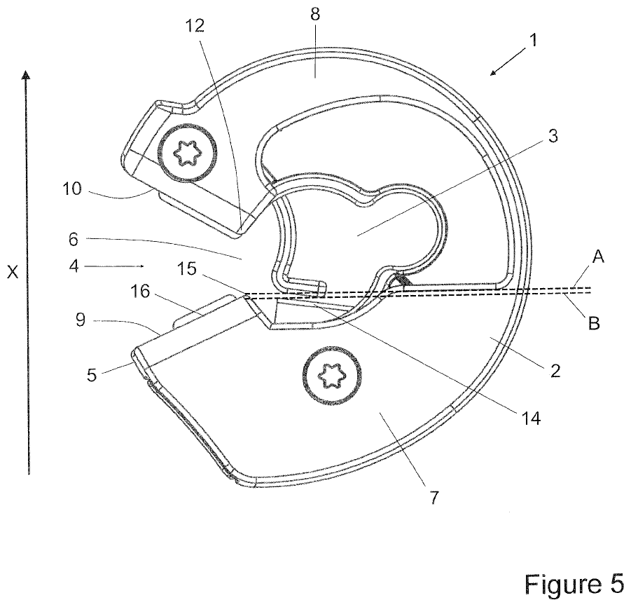

FIG. 5 is a side view of a tool according to a second embodiment, which differs from the tool of FIG. 1 only with regard to the profile of the blade;

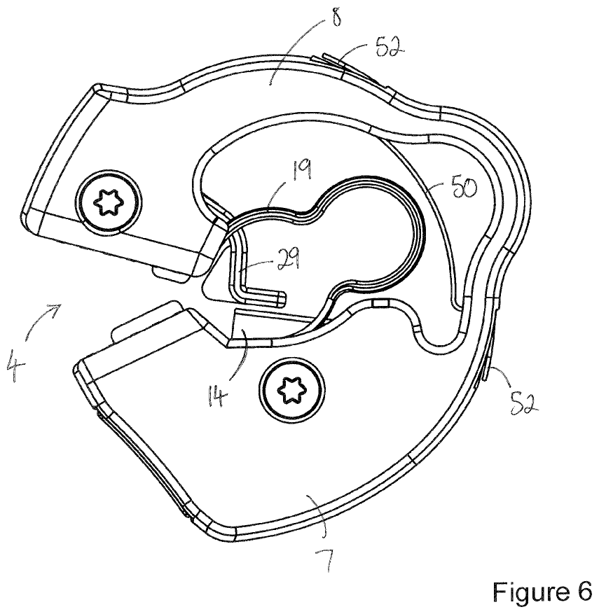

FIG. 6 is a side view of a tool according to a third embodiment, which differs from the tool of FIG. 5 primarily by the introduction of a biasing means;

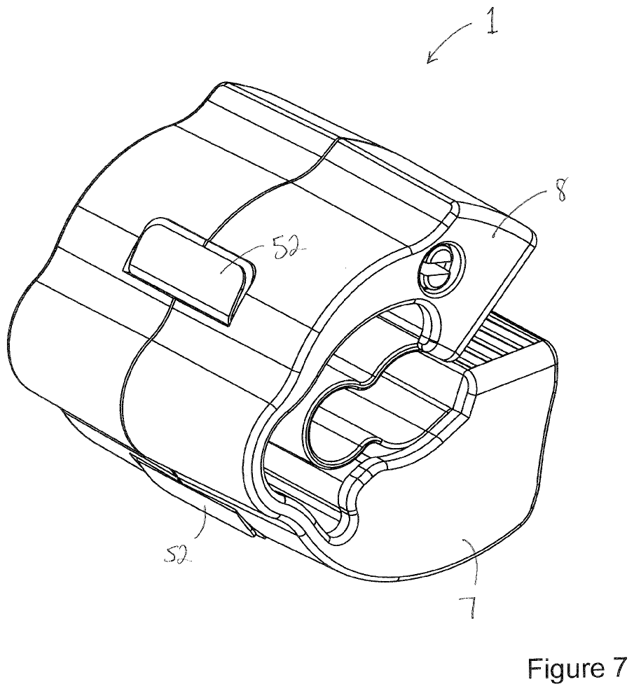

FIG. 7 is a rear perspective view of the tool of FIG. 6;

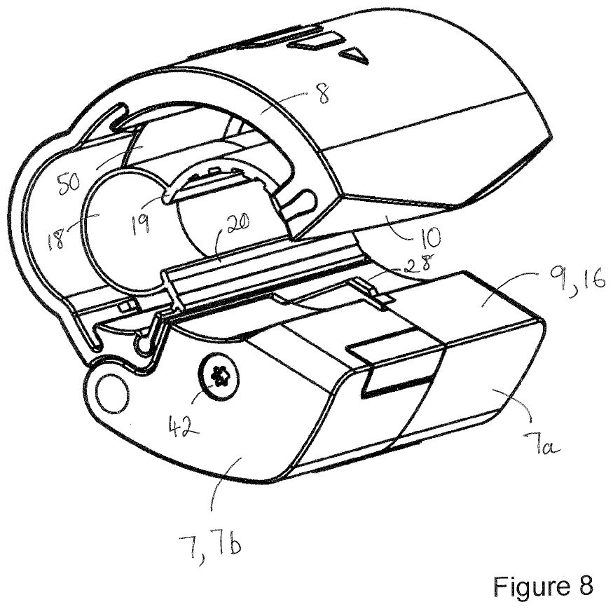

FIG. 8 is a perspective view of a tool according to a fourth embodiment of the present invention, as viewed from the front;

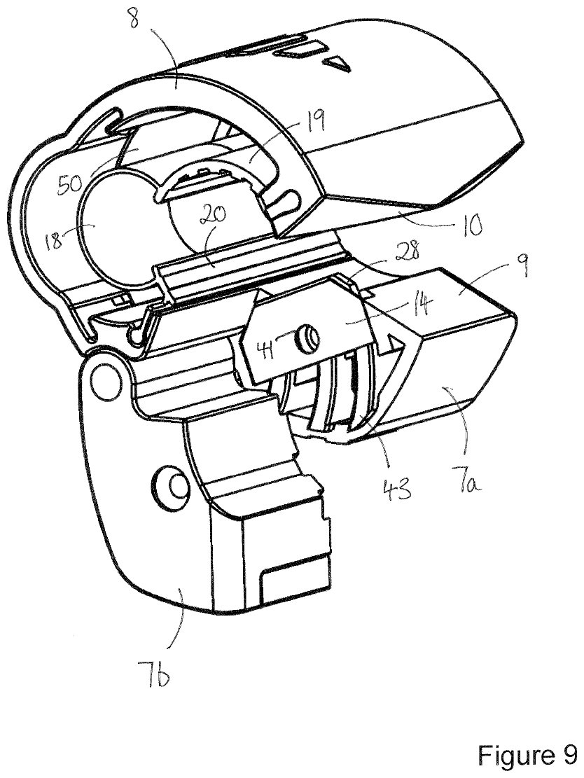

FIG. 9 is a perspective view of the tool of FIG. 8, opened to permit removal of the cutting blade;

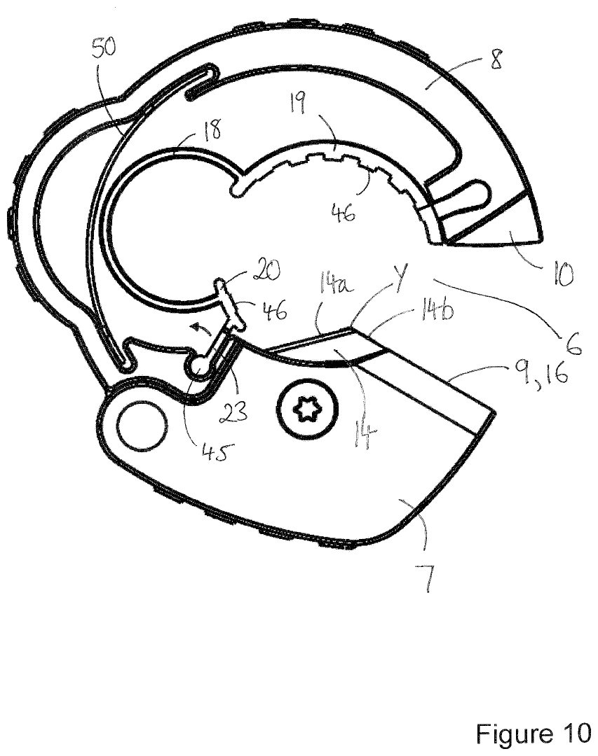

FIG. 10 is a side view of the tool of FIG. 8; and

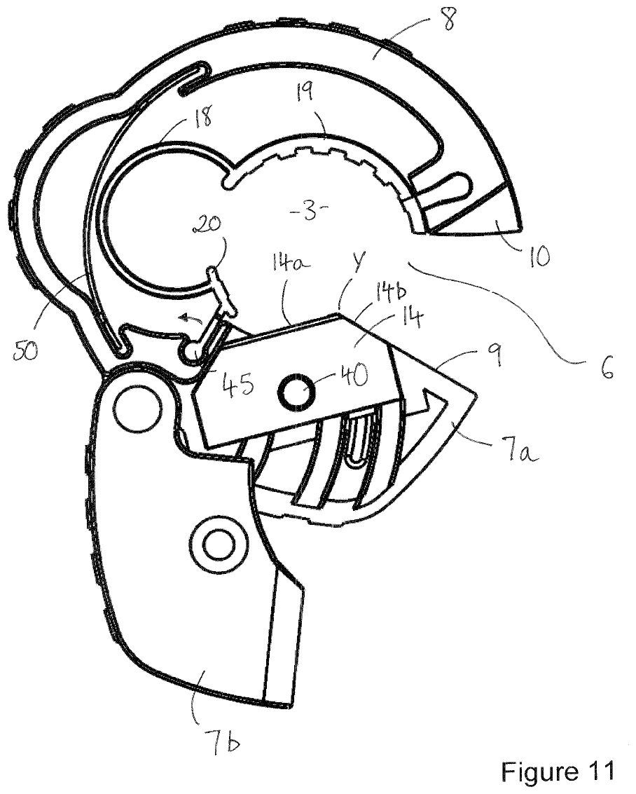

FIG. 11 is a side view of the tool, of FIG. 8 opened to permit removal of the cutting blade.

With reference to FIGS. 1 to 7, there is shown a tool 1 for cutting cylindrical conduits. The tool comprises a body 2 having an opening 3 extending along a predetermined axis through the body. A slot 4 extends from an external surface 5 of the body to a mouth 6 of the opening 3. A cutting blade 14 extends into the opening along a plane extending at right angles to said predetermined axis. The body has a first portion 7 on one side of the slot 4, and a second portion 8 on the other side of the slot.

Among key aspects of the tool of the present disclosure are the following first to third aspects, which aspects may be taken in any combination with one another, or which aspects may be taken in isolation from one another. For ease of description, the three aspects are shown together in the first to third embodiments presented herein. This should not be taken as limiting, however.

In a first aspect, the tool 1 is suitable for cutting cylindrical conduits of varied diameters. The tool comprises a flexible conduit holder 18 that is connected to the body and provided within the opening.

In a second aspect, at least a portion of a cutting edge of the blade 14 is recessed from the mouth 6 of the opening in a direction of a straight line extending between innermost edges 12, 15 of the slot 4 (as seen most clearly in FIG. 5).

In a third aspect, the slot comprises a pair of opposed sidewalls 9, 10 and one or both of the sidewalls is provided with an inwardly projecting protrusion 37 that lies in the plane of the blade 14, wherein the opening (and/or flexible conduit holder) is free from any such protrusion. In other words only the first and/or second sidewall comprises an inwardly projecting protrusion lying in the plane of the blade.

These three aspects will now be discussed in detail with reference to the depicted first to third embodiments:

In the depicted embodiments, the first portion 7 is generally rigid and inflexible and the second portion 8 is resilient and flexible. It should, however, be appreciated that in alternative arrangements both the first and second portions 7, 8 could be resilient and flexible.

The body of the tool is preferably generally cylindrical, as shown, wherein the predetermined axis of the opening 3 is the axis of the cylindrical body. The body is preferably formed from plastic or similar resilient material. The slot 4 preferably tapers so that its width progressively diminishes with distance from the external surface 5 to the mouth 6, as shown.

The second portion 8 comprises a head 11 located at its distal end, and a wall 13 having a generally arcuate shape, which wall 13 extends between the first portion 7 and the head 11. Second portion 8 is able to flex away from the first portion 7, whereupon the width of mouth 6 increases. Second portion 8 is resilient, such that it will resile to its original position shown in FIG. 2 when in a relaxed state (including following passage of a conduit through the mouth and into the opening 3).

The thickness of wall 13 is configured to provide the flexibility of second portion 8 relative to first portion 7. The second portion 8 having a reduced wall thickness compared to the first portion 7. The thickness of wall 13 may be constant between the head 11 and the first portion 7, or alternatively the width of the wall 13 may vary, as shown. Of course, in alternative arrangements the required flexibility could be provided by use of different materials or an alternative structure, such as an arrangement having voids or openings to introduce the required flexibility. As mentioned, in alternatives both the first and second portions 7, 8 may be flexible.

The slot 4 has a first sidewall 9 and a second sidewall 10. The first and second sidewalls 9, 10 are formed at the distal ends of first and second portions 7, 8 respectively. The first portion 7 is provided with the blade and the first sidewall 9 of the slot 4, comprises a guide surface 16. The cutting edge of the blade is recessed from an edge 15 of the guide surface 16 in the direction of the straight line extending between innermost edges 12, 15 of the slot (as shown most clearly in FIG. 5). The edges 12, 15 are located at the mouth 6 of the opening 3. They may be considered to define the mouth of the opening in the present embodiment. It should be noted that whilst the first portion is shown to be provided with the blade, alternative arrangements are possible in which the second portion is provided with the blade instead.

The tool 1 is configured to accept conduits of varied diameters, within a predetermined range. The width of the slot 4 between the first and second sidewalls at the external surface 5 may be configured to be larger than the largest diameter of the predetermined range, allowing any conduit within the predetermined range to be readily inserted into the slot. Furthermore, the width of the slot 4 at mouth 6 may be configured to be smaller than the smallest diameter of the predetermined range when the tool 1 is in a relaxed state. In this manner, any conduit having a diameter within the predetermined range which is progressively inserted along the slot 4 towards the opening 3 will engage the edge 12 of the second sidewall 10 and urge the second portion 8 to flex away from the first portion 7 until the conduit passes fully into the opening 3, at which point the second portion will resile to its relaxed state thus encompassing the conduit within the opening 3, and within the flexible conduit holder 18.

In the embodiment of FIG. 1, the blade 14 has an arcuate shape and is fixed. The blade 14 may alternatively be a circular blade which is rotatably supported within the body 2, such that the blade 14 is permitted to rotate, or may be square or rectangular blade, such as shown in FIG. 5. Preferably, the blade 14 extends into the opening by a distance exceeding the thickness of the wall of the conduit to be cut. In one embodiment, the distance to which the blade extends into the opening may be adjustable, such that the tool can be configured to cut conduits of varying wall thicknesses. Where the blade penetrates the flexible conduit holder 18 the wall thickness of the flexible blade holder will be taken into account. Moreover, where the blade is attached to the body and there is relative movement between the flexible conduit holder and the blade, with the flexible conduit holder moving towards or away from the blade with flexing of the tool/insertion of a conduit into the flexible conduit holder, the depth of exposure of the blade will be varied with such movement of the flexible conduit holder.

The flexible conduit holder 18 may be formed unitarily with the body 2. However, it is preferred that the flexible conduit holder 18 is separately formed to the body 2 and is attached thereto, as shown. The flexible conduit holder 18 preferably comprises a first conduit support portion 19 attached to the first portion 7 and a second conduit support portion 20 attached to the second portion 8. It is preferable that both conduit support portions comprise faces which are curved, as shown, alternative arrangements are possible where one or both of the faces is/are otherwise formed so as not to curve.

The flexible conduit holder 18 preferably has sufficient flexibility to permit insertion of any conduit having a diameter within the predetermined range, with the walls of the flexible conduit holder 18 conforming to the circumference of the conduit to support the conduit within the opening 3 during the cutting operation, whilst not deforming the conduit.

For clarity, FIG. 3 shows the flexible conduit holder 18 in isolation from the body 2. It will be appreciated that the features of the flexible conduit holder described hereafter with reference to FIG. 3 apply equally to embodiments of the present invention wherein the flexible conduit holder 18 is formed unitarily with the body 2 (by co-moulding/extrusion/printing or otherwise) or is formed separately to the body 2.

The spaced curved faces 19, 20 are joined to one another by an intermediate portion 21, which permits relative movement between the spaced curved faces 19, 20. The intermediate portion allows the curved faces 19, 20 to flex away from each other, preferably both pivotally and radially. As second portion 8 is displaced away from first portion 7, second/upper curved face 20 will flex away from lower/first curved face 19, thus allowing the flexible conduit holder 18 to accept any conduit having a diameter within the predetermined range. Upon full insertion of the conduit into the opening, the second portion 8, and thereby the flexible conduit holder 18 attached thereto, resiles and the curved faces 19, 20 substantially conform to the circumference of the conduit. The flexible conduit holder 18 thereby secures the conduit in position within the opening 3 without unduly compressing the conduit and supports the circumference of the conduit during the cutting operation. The conduit within the flexible conduit holder is urged against the blade 14, which penetrates the flexible conduit holder and pierces the wall of the conduit. Rotation of the tool 1 about the conduit will cause the blade 14 to sever the conduit progressively along its circumference.

The intermediate portion 21 may be a hinge joining the two curved faces 19, 20. As shown, the intermediate portion 21 may comprise a living hinge, wherein the hinge is formed of the same material as the curved faces 19, 20. The hinge is preferably arcuate in form. The wall of the hinge may be thinner than the walls of the curved faces 19, 20. Whilst it is preferred that the flexible conduit holder 18 is unitarily formed, in some arrangements a separate hinge, or alternative highly flexible intermediate portion, may be provided to join together the two curved faces 19, 20 and to permit relative movement between them.

As mentioned, the cutting blade 14 is provided within/fixed to the body 2, and protrudes through the flexible conduit holder 18 into the opening 3. To this end, an aperture 22 is provided in the flexible conduit holder 18 to permit the blade 14 to extend through the flexible conduit holder 18 and into the opening 3. The aperture 22 may preferably be formed as a slit, however the aperture 22 may have any such form as is suitable to allow the blade 14 to protrude through the flexible conduit holder 18 and into the opening 3. In the depicted arrangement the aperture is provided in the first curved face 19.

The flexible conduit holder may comprise a leg 23 extending outwardly from the first curved face 19. In this case, the body also comprises a channel 24 (not shown) for receiving the leg. The leg 23 provides a means to prevent ingress of dirt or other material beneath the flexible conduit holder 18 when the tool 1 is in a relaxed position. The leg will retract into the channel 24 when the tool 1 is opened to receive a conduit. The leg moves freely, slideably, within the channel 24. The leg may be omitted from any of the disclosed arrangements. It is shown omitted in FIG. 6. It may otherwise take alternative forms, such as that discussed with reference to the fourth embodiment, for example.

The flexible conduit holder 18 may further comprise rollers (not shown) provided within the curved faces 19, 20. Such rollers, when present, will assist the rotation of the tool around the conduit during the cutting operation. The rollers will have axes that are parallel with the axis of the opening 3.

Body 2 is preferably formed of two half portions 2A and 2B, which lie side by side along predetermined axis A, as shown in FIG. 1. The two half portions 2A and 2B are bolted together with a pair of bolts 26, 27 located with the first and second portions of the body, respectively. The blade 14 may be sandwiched between the two half portions 2A and 2B. The body may alternatively/additionally formed with a hinged part, as discussed with reference to the fourth embodiment below.

The tool 1 preferably further comprises a blade guard 28 pivotably attached to the second portion 8 and which, at rest, extends into the opening to cover the blade 14. As a conduit is inserted into the opening 3, the blade guard 28 pivots into the opening allowing the conduit to be accommodated by the flexible conduit holder 18. In the embodiment shown in FIG. 2, the blade guard 28 has a main body 29 and a foot portion 30, which foot portion extends across and above the top surface of the blade 14 to cover at least part of the blade 14. The blade guard is preferably resiliently biased into the rest/guard position seen in the figures. Alternative forms of blade guard are possible, as will be appreciated by those skilled in the art, including a blade guard that is slidably mounted, such as that shown in respect of the fourth embodiment.

The tool 1 may comprise a storage compartment 31 suitable for storing spare blades, as shown in FIG. 1.

As mentioned, at least a portion of the blade 14 is preferably recessed from the mouth of the opening in the direction of a straight line extending between innermost edges 12, 15 of the slot 4, i.e. in the direction X shown. The blade 14 is recessed from the mouth of the opening, as shown relative to lines A and B in FIG. 5. In this manner, a conduit which is inserted along the slot 4 into the opening 3 will not make contact with the blade until the entire conduit is fully inserted into the opening 3. This prevents the conduit from being unintentionally inserted into the opening 3 at an angle not parallel to the predetermined axis, by virtue of the conduit catching on the blade, which could result in an uneven severance of the conduit. It is preferable that the entire cutting edge of the blade is recessed from the mouth of the opening, as shown. In alternative arrangements, however, only a portion of the blade proximal the mouth of the opening may be recessed, with a portion of the blade distal the mouth not being recessed. In further alternative arrangements, the blade may not be recessed. Additionally, the blade could be configured in accordance with the blade of the fourth embodiment, or otherwise.

With the cutting edge of the blade 14 recessed from the edge 15 of the guide surface 16, in accordance with the depicted arrangement, a conduit which is progressively inserted along the slot 4 towards the opening 3 will be guided across the guide surface 16 from the external surface 5 to the mouth 6, where it will pass over the edge 15 of the guide surface 16 and into the opening 3, where it will make contact with the blade 14.

The guide surface 16 may comprise a ramp, as shown, which is generally inclined in the direction X from the external surface 5 to the mouth 6. The guide surface 16 may alternatively extend in a direction perpendicular to direction X, or may be declined with respect to direction X.

In the preferred arrangement, the sidewall of the slot which is associated with the respective one of the first and second portions that is provided with the blade (the sidewall 9 of the first portion 7 in the present arrangement) defines the guide surface 16. That is to say, the guide surface 16 is provided across the entire associated sidewall.

In alternative arrangements, the guide surface 16 may be formed by a projection on the associated sidewall of the slot 4, or by two or more spaced projections on the associated sidewall of the slot 4. Said projections may, for example, be formed on opposing lateral edges of the associated sidewall. Such projections may comprise ramps.

In the arrangement shown, the guide surface 16 is straight. However, in alternative embodiments, the guide surface may be curved.

As seen in FIG. 5, the cutting edge may be increasingly recessed from the mouth of the opening as it extends away from the mouth of the opening. This is particularly the case when the cutting edge is straight.

It may be desirable to cut corrugated conduits. Such conduits 34 consist of a series of axially spaced peaks 35 and troughs 36. Such conduits need to be cut by severing the pipe at right angles to their central axis in a trough and the conduit must therefore be aligned with the cutting blade accordingly.

To this end, as mentioned, one or both of the sidewalls 9, 10 may be provided with an inwardly projecting protrusion 37 that lies in the plane of the blade 14. Importantly the opening 3 (or flexible conduit holder 19 where present) is free from any such protrusion. By only providing the protrusion(s) on the sidewall(s), it is possible for the tool to be used for cutting both corrugated conduits and conduits having smooth outer surfaces. The protrusions may comprise ribs projecting inwardly generally at right angles to the predetermined axis, the ribs each having a length dimension in the direction from the external surface of the body to the mouth of the opening. In alternative arrangements, in place of ribs, studs or similar projections may be provided in isolation or in rows, for example. Numerous alternatives will be readily appreciated by those skilled in the art.

In FIG. 5, protrusions 37, in the form of ribs, are provided on both the first sidewall 9 and the second sidewall 10 of the slot 4. The ribs 37 extend partially across the first and second sidewalls 9, 10 in the direction from the external surface 5 of the body 2 to the mouth 6 of the opening 3. They could, however, extend the full lengths of the sidewalls in the direction from the external surface 5 of the body 2 to the mouth 6 of the opening 3 in alternative arrangements. The ribs 37 are aligned in the plane of the cutting blade 14 perpendicular to the predetermined axis. A corrugated conduit can be inserted along the slot 4 by causing the ribs 37 to engage with a trough of the conduit. As the conduit is inserted into the opening 3, the ribs guide the trough to be positioned over the cutting blade 14, whereby the cutting operation can be carried out.

At least one of the protrusions may be retractable or removable.

In the arrangements of FIGS. 1 and 5, the rib 37 on the first sidewall 9 is formed by a removable insert 50. The insert is slideably received by the body 1. It is receivable by the body in first and second orientations, wherein the protrusion only projects from the guide surface in the first orientation, as seen in FIG. 5. In a second orientation, as shown in FIG. 1, the insert does not project but rather, as is preferable, lies flush with the guide surface 16. The first and second orientations are arranged at 180 degrees to one another. The body is provided with a suitably profiled guide channel, with keyed sidewalls or otherwise, to receive the insert 50 in both orientations.

Note that in the arrangement of FIG. 1, the rib 37 on the second sidewall 10 is omitted whilst in the arrangement of FIG. 5 it is included. In any arrangement it may be included or removed. When provided it could also be formed by a removable insert. Moreover, whilst the rib 37 on the first sidewall is shown to be provided on the insert to render it removable, it could be moulded or otherwise formed as a permanent feature.

In alternative arrangements, as will be readily appreciated by those skilled in the art, rather than providing the protrusion 37 on a reversible insert, the protrusion 37 on either of the first or second sidewalls could be slideably mounted to selectively protrude from or retract into a slot provided in the face of the sidewall. Numerous alternative arrangements will be readily conceived by those skilled in the art to allow for a retractable or removable protrusion.

In accordance with the embodiment of FIGS. 6 and 7, any of the above described embodiments may further be provided with a biasing means 50. The biasing means 50 is provided for enhancing the “memory” of the tool. It aids the body of the tool retain its original shape when in a relaxed/rest state even after multiple deformations. FIGS. 6 and 7 show the tool in a relaxed/rest state. The biasing means biases the first and second portions of the body apart from one another. It maintains the tool in a predetermined rest position with the mouth of the opening open.

The biasing means 50 in the present arrangement comprises a suitably shaped strip of spring steel, which extends between the first and second body portions to urge them apart to the rest position shown in FIG. 6. The spring may be formed from a different metal. The spring is provided rearwards of the flexible conduit holder from the slot. It may be otherwise located as long as it does not interfere with the flexible conduit holder. At rest the spring adopts the form shown in FIG. 6. The spring is formed separately to the body of the tool. In the present arrangement, the first and second body portions are provided with slots that receive opposed ends of the spring that define tabs 52. The spring is trapped in the slots. It should be appreciated, however, that the spring may take numerous alternative forms and may be alternatively held or fixed in place. One such alternative arrangement is shown in respect of the fourth embodiment, as best seen in FIG. 10. In alternative arrangements, for example, the spring may comprise a coil spring fixed in place using screws. Moreover, whilst the spring lies within the opening of the body in the present arrangement, it could lie outside the opening, received entirely within the body. It could be embedded therein, or otherwise.

Among further key aspects of the tool of the present disclosure are the following fourth and fifth aspects, which aspects may be taken in any combination with one another and/or the first to third aspects above, or which aspects may be taken in isolation from one another. For ease of description, the two aspects are shown together in the fourth embodiment presented hereafter. This should not be taken as limiting, however.

In a fourth aspect, the first portion 7 comprises a first part 7a, which is attached to the second portion 8, and a second part 7b, which is hinged to rotate relative to the first part 7a about an axis.

In a fifth aspect, a leading end Y of a cutting of the cutting blade is provided proximal the mouth of the opening 3, and a ramp 14b is provided, which tapers away from the leading end Y of the cutting edge 14a in a direction towards the mouth 6 of the opening 3.

These two aspects will now be discussed in detail with reference to the depicted fourth embodiment, however, as discussed, the features of the fourth embodiment, including the features relating to the fourth and fifth aspects, may be combined with features of the first to third embodiments and vice versa, including any discussed alternatives.

Like numbering will be used in respect of the features that are common with or equivalent to the features of the first to third embodiments.

As best seen in FIGS. 10 and 11, the first portion 7 comprises a first part 7a, which is attached to the second portion 8, and a second part 7b, which is hinged to rotate relative to the first part 7a about an axis. The axis in the present arrangement is parallel to the predetermined axis A. It should be noted, however, that in other arrangements, it could be alternatively oriented. For example, it could be perpendicular to the predetermined axis. Whilst, as mentioned above, the feature of the hinged second part 7b may be taken in combination with the feature of the body 2 being formed of two half portions 2A and 2B, which lie side by side along predetermined axis A (as shown in FIG. 1), it is preferred that the body 2 is not formed in two halves. It is most preferable that the first part 7a is unitarily formed with the second portion 8a and that the second part 7b is hingedly attached thereto, although this need not be the case.

The cutting blade 14 is sandwiched between the first and second parts 7a, 7b as clearly shown in FIGS. 8 to 11. Most preferably, a suitably sized and shaped recess is provided in an end face of the first part 7a for supporting the blade. A protrusion 40 may be provided, which is received by a corresponding opening 41 in the blade to locate and fix the blade against movement in the plane of the blade, as is conventional in the art. The second part is rotatable between a first position, as shown in FIGS. 8 and 10, in which the blade is obstructed to prevent its removal and a second position, as shown in FIGS. 9 and 11, in which the blade can be removed/replaced. In the first position the first and second parts entirely overlap with one another, as best seen in FIG. 10. The first and second parts 7a, 7b combine to define a sidewall 9 of the slot 4 when in the first position, wherein the sidewall 9 defines a guide surface 16 for a conduit to be cut.

By the provision of the hinged second part 7b, the replacement of the blade 14 is possible without the need to dismantle the tool. Moreover, an arrangement is possible in which only a single locking means needs to be manipulated to allow for the removal/replacement of the cutting blade 14. In the present arrangement, a single screw 42 is undone to allow for the rotation of the second part 7b between the first and second positions. The locking means could, of course, take numerous alternative forms and is not limited to the arrangement shown.

The first and second parts 7a, 7b preferably interlock with one another to unify the first and second parts 7a, 7b in the first portion 7. For this purpose, the abutting faces of the first and second parts, one of which comprises the blade supporting end face, are provided with interlocking members 43. In the present arrangement, as shown, the interlocking members 43 comprise a plurality of corresponding arced ribs and grooves, which are concentric about the axis of rotation of the second part. It must be appreciated that in alternative arrangements, there may be more or less interlocking members provided, which may be alternatively formed.

As best seen in FIGS. 10 and 11, the cutting blade comprises a cutting edge 14a and a ramp 14b, the leading end Y of the cutting edge 14a being provided proximal the mouth 6 of the opening 3, and the ramp 14b tapering away from the leading end Y of the cutting edge 14a in a direction towards the mouth 6 of the opening 3.

In the present arrangement, as is preferred, the ramp 14b is defined by a non-cutting edge of the cutting blade. In alternative arrangements, however, it could be separately formed to the cutting blade, either attached to or integrally formed with the body. It could in such circumstances comprise a rib or fin. It could be formed from metal or plastic. It preferably has the same thickness as the cutting blade.

The arrangement is such that during insertion of a conduit into the cutter for cutting will contact the ramp/non-cutting edge 14b before the cutting edge 14a. The ramp/non-cutting edge 14b is a blunt edge, whilst the cutting edge 14a is a sharp edge. The discussed features of the non-cutting edge below are equally applicable to a separate ramp, as discussed above.

Whilst in the present arrangement both the cutting and non-cutting edges are straight, which is preferred, one or both of these edges may be curved. The cutting edge 14a and the non-cutting edge 14b are preferably arranged at an oblique angle to one another. The oblique angle may, for example, be any angle between 30 and 60 degrees. In the present arrangement it is 45 degrees. The cutting edge 14a and the non-cutting edge 14b may meet at a vertex of the cutting blade, as best shown in FIG. 10. In the present arrangement, this vertex is the leading end Y of the cutting edge 14a.

In the present arrangement, the cutting blade extends into the opening 3 by the greatest depth at the leading end Y of the cutting edge 14a, as best seen in FIG. 10. This need not be the case, however. The blade 14 could, for example, be positioned or shaped differently. It is also preferable that the depth of extension of the cutting edge of the blade into the opening 3 diminishes with distance away from the mouth 6 of the opening, as best seen in FIG. 10, although, again, this need not be the case.

Whether or not the first portion 7, which is provided with the blade 14, comprises the first and second parts 7a, 7b, it is preferred, as mentioned above, that the sidewall 9 of the slot, which is associated with the first portion 7 comprises a guide surface 16, and the non-cutting edge 14b of the blade is aligned with the guide surface 16, as again best seen in FIG. 10. With a straight guide surface and a straight non-cutting edge 14b, the guide surface 16 and the non-cutting edge 14b are substantially co-planar. Regardless of whether they are straight or curved, it is beneficial, as shown, that they together define a ramp along which a cylindrical conduit may travel before engaging the cutting edge of the cutting blade. A conduit introduced into the slot 4 will, with progressive insertion into the opening, ride up the ramp and will only engage the cutting edge 14a of the blade when it is fully inserted into the opening 3 and suitably supported by the flexible conduit holder.

The flexible conduit holder of the fourth embodiment differs slightly in structure from the flexible conduit holders discussed above with respect to the first to third embodiments. Only the differences are considered here. Any of these features or any combination of these features may be introduced into any of the earlier embodiments.

The flexible conduit holder again comprises spaced conduit support portions 19, 20 that are joined to one another by an intermediate portion 21, which permits relative movement between the spaced conduit support portions 19, 20, allowing the conduit support portions 19, 20 to flex away from each other, preferably both pivotally and radially. Preferably, both conduit support portions comprise curved faces. As discussed, however, it need not necessarily be the case that both conduit support portions define faces, or faces which are curved. The conduit support portion 21 in the present arrangement is reduced in size relative to the conduit support portion 21 of the earlier embodiments and is set further back in the opening from the mouth 6. Accordingly, the blade does not protrude though the flexible conduit holder.

The flexible conduit holder is fixed to the first portion by a leg 23. The leg 23 has a different form to the leg 23 described in respect of the first to third embodiments. The leg 23 is again preferably flexible. It is, however, preferably hingedly received by the opening. For this purpose, an edge portion of the leg that is received by the opening may have an enlarged section 45 which is held in a complimentary enlarged section of the opening, as best seen in FIG. 10. The enlarged sections may be in the form of a ball and socket when viewed in cross-section, as shown. The shapes and dimensions of the leg and opening may permit rotation of the leg within the opening, as indicated by the arrow in FIG. 10, but prevent movement of the leg out of the opening. The rotation of the leg will be restricted by the opening itself to define a limited degree of rotation within predetermined limits. The opening preferably comprise a channel for receiving the leg, as best seen in FIGS. 8 and 9. The leg preferably extends along substantially the entire length of the flexible conduit holder in the axial direction, as shown. It is to be noted that the opening may take alternative forms or, moreover, that the opening may be omitted with the leg otherwise fixed to the body. A hinged arrangement could, for example, be formed by a living hinge. The leg could be welded, glued, screwed or otherwise fixed to the body.

The leg may provide the sole attachment point of the flexible conduit holder to the first portion 7. The curved face 20 may be fixed to the first portion 7 via the leg.

One or both of the first and second curved faces 19, 20 may be provided with one or more projections or indentations 46. The projections or indentations 46 may define ribs that extend parallel to the predetermined axis. The projections may take numerous alternative forms or could be omitted. Moreover, they may be incorporated in any of the other embodiments. They act to reduce the contact area with a conduit received by the pipe to thereby aid in its removal by reducing friction.

The blade guard 28 in the present arrangement is slidably mounted to the body. It is spring loaded into the position shown in FIGS. 8 and 9. It could be omitted or alternatively formed.

Whilst all aspects have been described in the context of embodiments that include the first aspect, it should be noted that the second, third, fourth and/or fifth aspects could be applied to a cutter of a form similar to that shown in UK Patent No GB 2457346, i.e. a cutter which omits the flexible conduit holder of the first aspect.

The invention has been described above with reference to specific embodiments, given by way of example only. It will be appreciated that many different arrangements of the system are possible, which fall within the scope of the appended claims.

Applicant amends the claims as follows:

1. A tool for cutting cylindrical conduits of varied diameters, said tool comprising:
a body having an opening extending along a predetermined axis through the body,
a slot extending from an external surface of the body to a mouth of the opening, a first portion of the body being provided on one side of the slot and a second portion of the body being provided on the other side of the slot,
a cutting blade extending into said opening along a plane extending at right angles to said predetermined axis, and
a flexible conduit holder that is connected to the body and provided within the opening.

2. A tool as claimed in claim 1, wherein the flexible conduit holder is separately formed to the body and is attached thereto.

3. A tool as claimed in claim 2, wherein the flexible conduit holder is formed of metal or plastic.

4. (canceled)

5. A tool as claimed in claim 1, wherein the flexible conduit holder is unitarily formed.

6. A tool as claimed in claim 1, wherein the flexible conduit holder comprises a hinge.

7. A tool as claimed in claim 6, wherein the hinge is a living hinge.

8. A tool as claimed in claim 7, wherein the living hinge has a curved profile.

9. A tool as claimed in claim 1 wherein the flexible conduit holder comprises a pair of spaced conduit support portions that are joined to one another by an intermediate portion that permits relative movement between the spaced conduit support portions.

10. A tool as claimed in claim 9, wherein one or both of the conduit support portions comprises a face, which may be curved.

11-13. (canceled)

14. A tool as claimed in claim 1, wherein the flexible conduit holder is attached on a first side thereof to the first portion of the body and is attached on a second side thereof to the second portion of the body.

15. A tool as claimed in claim 1, wherein the flexible conduit holder spans the mouth of the opening.

16. A tool as claimed in claim 1 wherein a portion of the flexible conduit holder that is located beyond a portion of a cutting edge of the blade, when viewed through the slot, is flexibly mounted.

17. (canceled)

18. A tool as claimed in claim 1, wherein the flexible conduit holder comprises an outwardly extending leg.

19-21. (canceled)

22. A tool as claimed in claim 1, wherein the flexible conduit holder extends along substantially the entire axial length of the opening.

23. A tool as claimed in claim 1, wherein the slot tapers so that its width progressively diminishes with distance from the external surface of the body to the mouth of the opening.

24-37. (canceled)

38. A tool as claimed in claim 1, wherein at least a portion of a cutting edge of the blade is recessed from the mouth of the opening in a direction of a straight line extending between innermost edges of the slot.

39. A tool as claimed in claim 38, wherein the entire cutting edge of the blade is recessed from the mouth of the opening.

40. A tool as claimed in claim 38, wherein one of the first and second portions is provided with the blade, and a sidewall of the slot, which is associated with the respective one of the first and second portions that is provided with the blade, comprises a guide surface, and the cutting edge of the blade is recessed from an edge of the guide surface in the direction of the straight line extending between innermost edges of the slot, which edge is located at the mouth of the opening.

41-45. (canceled)

46. A tool as claimed in claim 40, wherein the cutting edge is increasingly recessed from the mouth of the opening as it extends away from the mouth of the opening.

47-87. (canceled)

88. A tool as claimed in claim 1 further comprising a spring for biasing the first and second portions of the body apart from one another.

89-98. (canceled)
